(19) United States
(12) Patent Application Publication
(10) Pub. No.: US 2012/0293746 A1
(43) Pub. Date: Nov. 22, 2012

(54) LIGHT GUIDE MODULE AND BACKLIGHT USING SAME

(76) Inventors: Sijing Li, Shanghai (CN); Xingpeng Yang, Shanghai (CN); Hua Xiang Xie, Suzhou (CN)

(21) Appl. No.: 13/522,617

(22) PCT Filed: Jan. 19, 2011
(86) PCT No.: PCT/US2011/021699

§ 371 Date: Jul. 17, 2012

(30) Foreign Application Priority Data
Jan. 20, 2010 (CN) 201010004679.3

(51) Int. Cl. G02B 6/10; G02F 1/13357; G02B 6/34

(52) U.S. Cl. 349/65; 385/129; 385/36

(57) ABSTRACT

A light guide module (4) and backlight that incorporates this module are disclosed. In some embodiments, a light guide module includes a light guide (1) having an input surface (11) to receive light. The module also includes a structured surface layer (2) including a first surface (812) and a second surface (13). The first surface (12) is attached to the input surface (11) of the light guide (1). And the second surface (13) includes microstructures (21) that are operable to spread incident light in the plane of the light guide (1). The second surface (13) is positioned to receive light emitted from an array of light emitting diodes (3).

### CROSS REFERENCE TO RELATED APPLICATION

This application claims the benefit of China Patent Application No. 201010004679.3, filed Jan. 20, 2010, the disclosure of which is incorporated by reference herein in its entirety.

### FIELD

The present disclosure relates to liquid crystal displays. More specifically, the disclosure relates to a type of module used in backlights, its manufacturing method, and the liquid crystal display panel incorporating the disclosed module.

### BACKGROUND

Liquid Crystal Display (LCD) panels are currently mostly designed using Cold Cathode Fluorescent Lamps (CCFL) for the backlight. Recently, manufacturers have begun replacing CCFLs with other types of light sources, such as light-emitting diodes (LEDs), which are more energy efficient and environmentally friendly than CCFLs.

In backlighting applications for display panels, the main difference between CCFLs and LEDs is that CCFLs continuously emit spatial light in a linear manner, while LEDs combine equally spaced apart single-point light sources arranged into an LED light bar. As such, CCFLs will likely provide uniform illumination. On the contrary, when using light bars made up of arrays including single-point highly efficient LEDs as light sources, as the distance between adjacent LEDs increases, certain areas directly in front of each LED may appear brighter, and the areas between LEDs appear darker, thereby resulting in non-uniform brightness of the areas of the light guide closest to the LEDs.

### SUMMARY

In one aspect, the present disclosure provides a light guide module that includes a light guide having an input surface to receive light. The light guide module also includes a structured surface layer that has a first surface and a second surface, where the first surface is attached to the input surface of the light guide. The second surface includes microstructures that are operable to spread incident light in the plane of the light guide. And the second surface is positioned to receive light emitted from an array of light emitting diodes.

### BRIEF DESCRIPTION OF THE DRAWINGS

Throughout the specification, reference is made to the appended drawings, where like reference numerals designate like elements, wherein:

FIG. 1 is a schematic cross-section view of scattering of incident rays by microstructures positioned on a surface of an injection molded light guide;

FIG. 2 is a schematic plan view of one embodiment of a backlight that includes a light guide module and an array of light emitting diodes;

FIGS. 3A-B are micrographs of another embodiment of a light guide module that includes a structured surface layer positioned on an input surface of a light guide;

FIG. 4 is a schematic plan view of another embodiment of a light guide module;

FIG. 5 is a schematic plan view of another embodiment of a light guide module;

FIGS. 6-7 are graphs of light intensity versus position for various embodiments of light guide modules; and

FIGS. 8A-F are schematic cross-section views of various embodiments of microstructures.

### DETAILED DESCRIPTION

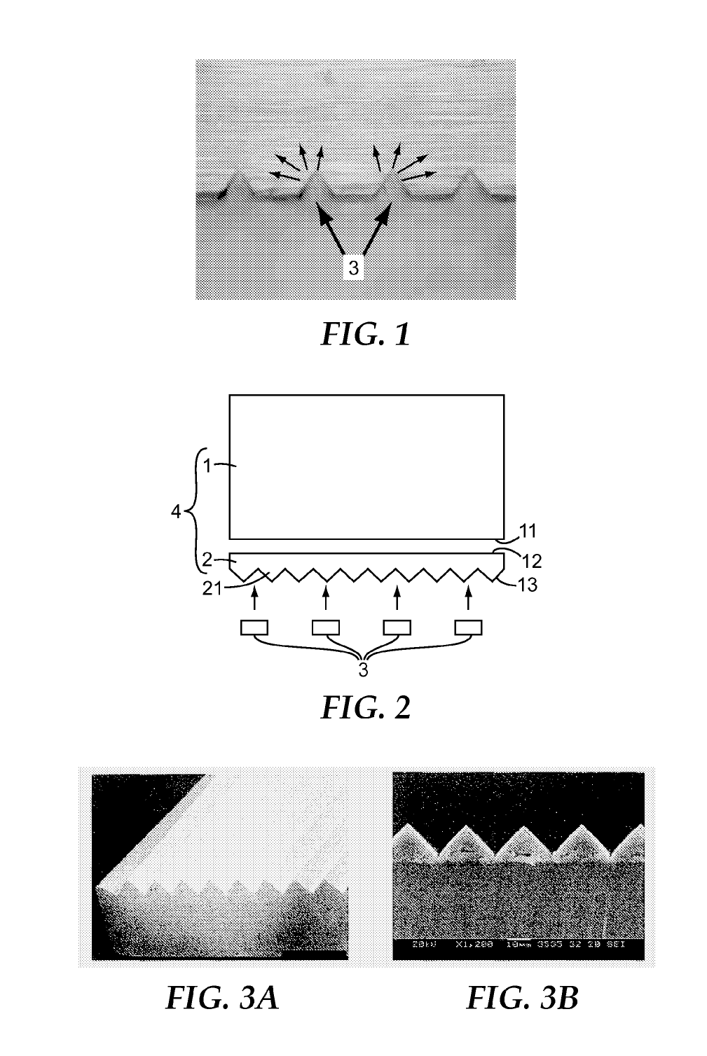

To overcome the problem of incident rays entering the light guide that causes non-uniformity of brightness in areas of the display panel that are closest to the light sources, some protrusions or depressions may be created through injection molding at the input surface so as to spread the light and reduce dark zones as shown in FIG. 1. In addition, the distance between the light sources and the border of the effective display area can be increased to allow the incident light to spread before entering the light guide.

However, if the foregoing techniques are applied directly to the microstructures, the following problems can arise:

1. As the light guide used in backlighting of display devices is produced from the printing process, the existing process flows are not capable of producing the microstructures contained in the cross sections of light guides that are useful for scattering light. Further processing is necessary by relying on other etching techniques, thereby introducing more procedures into the production process flow and increasing processing costs.

2. As it is relatively more difficult to estimate the quantity, luminous efficiency and emission distribution of LEDs during the backlight design phase, any optimization or improvement to the existing microstructure distribution may cause the design and production processes to become more complicated.

Therefore, the present disclosure proposes a type of light guide module to improve and optimize the uniformity of brightness in areas closer to the light source, reduce production costs, and simplify the production process.

FIG. 2 illustrates one embodiment of a light guide module. The light guide module 4 includes a light guide 1 having an input surface 11 to receive light and a structured surface layer 2. The structured surface layer 2 includes a first surface 12 and a second surface 13. The first surface 12 is attached to the input surface 11 of light guide 1. The second surface 13 includes microstructures 21 that are operable to spread incident light in the plane of the light guide 1. In some embodiments, the first surface 12 can be attached to the input surface 11 using adhesives, welding, or any other suitable technique. The second surface 13 is configured to receive incident light from one or more light sources.

FIG. 2 also illustrates the working layout of the foregoing light guide module 4 as used in a backlight that can provide illumination to an LC display, sign, etc. The backlight can include an array of light emitting diodes 3, where a distance between two adjacent single-point light emitting diodes (in array 3) can be an suitable value, e.g., greater than 5 mm, 10 mm, 15 mm, 20 mm, or greater. The array of light emitting diodes 3 is placed in parallel with and faces the second surface 13 so that at least a portion of light emitted from the array 3 will enter the light guide plate 4 through the second surface 13. Light emitted from the array 3 enters light guide module 4 though the second surface 13, and provides backlighting, e.g., to the entire liquid crystal display panel through light guide 1. Due to the role of microstructures 21, light emitted from the array 3 is spread in the plane of the light guide 1, thereby increasing the uniformity of light intensity proximate the light incident area of the light guide, thereby increasing the efficiency of backlighting design. In some embodiments, the light emitting surfaces of the array 3 can be placed in parallel with and facing the input surface 11 of the light guide 1 so as to ensure that light enters vertically into the light guide plate module further improving the radiation efficiency of the light guide module 4.

Microstructures 21, as illustrated in FIG. 2, are symmetrical prism microstructures. It should be noted that the dimensions of the microstructures illustrated in FIG. 2 are exaggerated for the sake of clarity. The specific dimensions of the prism structures can be chosen based on individual needs.

FIGS. 3A-B are micrographs of one embodiment of a structured surface layer with a symmetrical prism structure. As illustrated in the Figures, the cross sectional views of the prisms show isosceles triangle shapes with an apex angle and two equal base angles. The dimensions of prism structure is on the order of 10 microns. However, it should be understood that FIGS. 3A-B are merely exemplary embodiments for the dimensions of the prism structure of the present disclosure, which shall in no way limit the dimensions of the present disclosure.

The apex angles of the foregoing prism structure can be any suitable value, e.g., at least 72 degrees. In some embodiments, the apex angle can be no greater than 120 degrees.

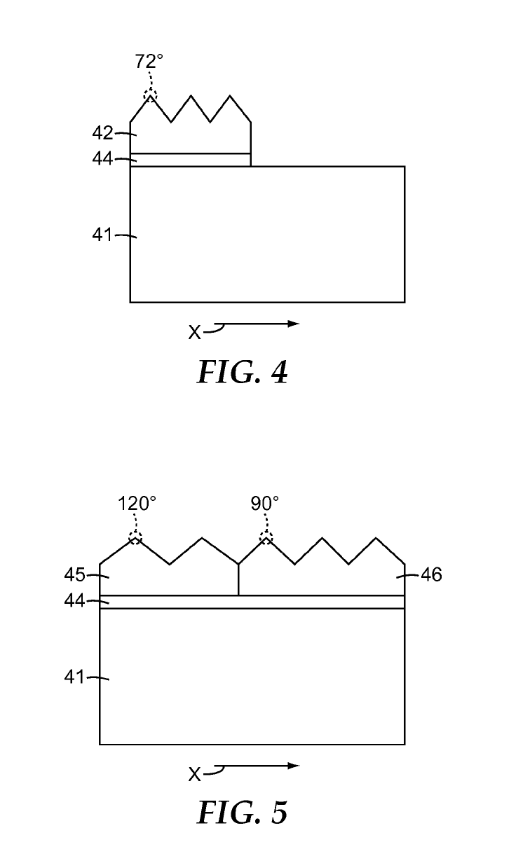

FIGS. 4-5 illustrate various embodiments of light guide modules using structured surface layers that include structures having various apex angle values.

FIG. 4 illustrates an embodiment of a light guide 41 for a 17-inch display panel. The light guide 41 has a thickness of 8 mm. Its input surface is split into 2 sections, where a structured surface layer 42 having symmetrical prism microstructures each with a prism angle of 72 degrees is attached to its left section (as shown in the Figure) using an adhesive layer 44 (e.g., a pressure-sensitive adhesive), while its right section maintains its original optical surface without attaching any structured surface layer. An array of LEDs having a 10 mm spacing between LEDs is placed in parallel with and facing the input surface of the light guide so that at least a portion of light emitted from the LEDs can directly enter the input surface.

The embodiment illustrated in FIG. 5 is similar to that in FIG. 4, where the input surface of a light guide 41 is split into two sections, except that the prism angle of the attached structured surface layers is different from that of FIG. 4 and include structured surface layer 45 having symmetrical prism microstructures each with a prism angle of 120 degrees, and structured surface layer 46 having symmetrical prism microstructures each with a prism angle of 90 degrees, respectively.

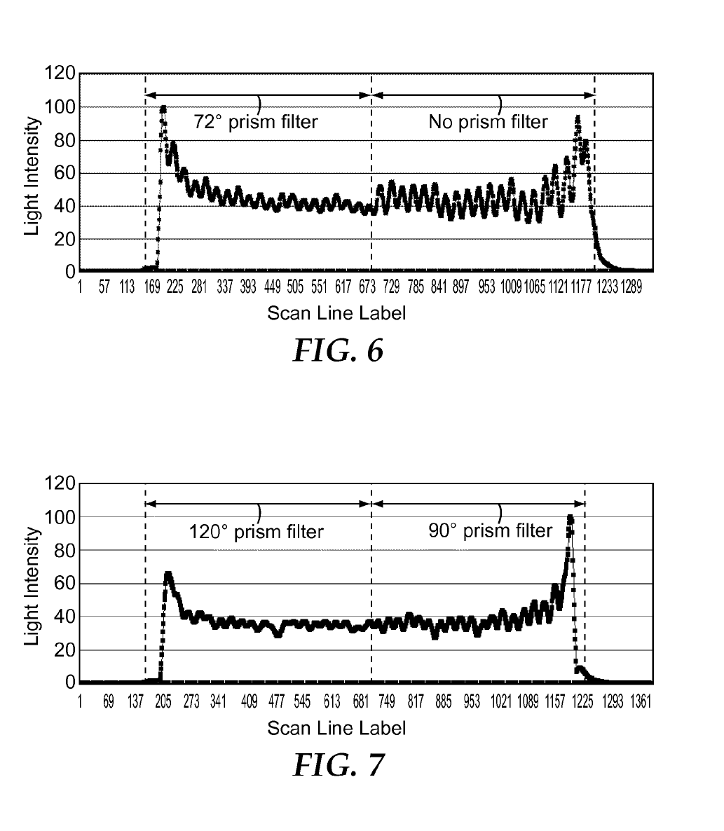

The uniformity of light intensity at the incident areas of light sources as obtained from the structures illustrated in FIGS. 4-5 are respectively illustrated in FIGS. 6-7. The horizontal coordinates in FIGS. 6-7 refer to the scan line labels, i.e., the horizontal coordinates along the LEDs placed side by side (e.g., the X direction as illustrated in FIGS. 4-5), while the vertical coordinates indicate light intensity. In FIG. 6, the left half corresponds to a light guide module having a structured surface layer 42 that includes microstructures each with a prism angle of 72 degrees, while the right half corresponds to a light guide module without any structured surface layer. In FIG. 7, the left half corresponds to a light guide module having a structured surface layer 45 with microstructures each having a prism angle of 120 degrees, while the right half corresponds to a light guide module having a structured surface layer 46 with microstructures each having a prism angle of 90 degrees. As can be seen in FIGS. 6-7, light guide modules using structured surface layer 45 provide improved uniformity in light intensity, while the uniformity for light guide modules having structured surface layers 42 and 46 with prism angles of 72 and 90 degrees, respectively, are also apparently improved over the light guide module that does not include a structured surface layer.

Another embodiment of the present disclosure is to provide a method of manufacturing a type of light guide module. Using FIG. 2 as an example, first a light guide 1 including input surface 11 to receive light is provided, and a structured surface layer 2 can be attached to the input surface 11, where the layer 2 includes a first surface 12 and a second surface 13, and the first surface 12 is attached to the input surface 11 of the light guide 1, while the second surface 13 includes microstructures 21. The specific technique used to attach the first surface 12 of the layer 2 to the input surface 11 can be by use of adhesives, welding, or any other suitable technique. The dimensions of the structured surface layer 2 can be consistent with the cross sectional dimensions of the input surface 11, e.g., 42 mm×8 mm.

During the production process, a coil method can be used to produce the structured surface layer, and a plastic film coating process can be used to coat a plastic layer evenly onto the bottom of the structured surface layer and then a ground protective film can be attached. This is followed by cutting the structured surface layer into strips with dimensions that are consistent with the cross sectional view of the input surface 11 of the light guide 1, and then the layer can be attached to the input surface 11 of the light guide 1.

When incorporating the foregoing light guide module into liquid crystal display devices, an array of light emitting diodes 3 can be placed in parallel and facing the second surface 13 of the structured surface layer 2 so that at least a portion of light emitted from the array of light emitting diodes 3 will enter the light guide 1 through the second surface 13. In this way, light emitted from the array of light emitting diodes 3 entering the light guide will be spread by the microstructures 21, thereby increasing the uniformity of light intensity in the light guide. The light emitting surfaces of an array of light emitting diodes 3 can be placed in parallel and facing the input surface 11 of the light guide plate module 4, so as to ensure that at least a portion of light vertically enters into the light guide module 4, thereby increasing the radiation efficiency of light guide module 4.

The foregoing technique makes use of a light guide in conjunction with a structured surface layer, and not any complicated process such as injection molding or etching of microstructures onto the input surface of the light guide, thereby lowering product costs and simplifying processes. In particular, when there is a need to optimize the specific distribution and shape of the microstructures, the structured surface layer can be repeated without any need to repeatedly create molds for new light guides.

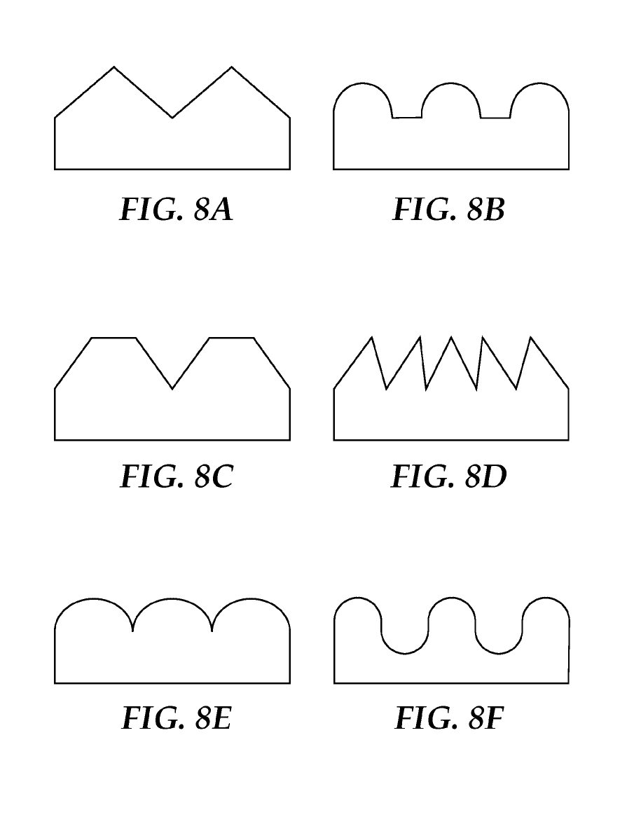

In the foregoing accompanying drawings and descriptions, symmetrical prism microstructured surface layers are used as exemplary embodiments to describe the light guide module. However, those skilled in the art will understand that the structured surface layers of the present disclosure can assume a wide variety of structural forms to satisfy different needs. For example, FIG. 8 illustrates various embodiments of shapes of microstructures that may possibly be used, including, but not limited to, symmetrical prism, intermittent arc, continuous arc, trapezoidal, Fresnel, or sinusoidal shapes.

Notwithstanding the fact that the foregoing accompanying drawings have only illustrated one input surface attached to the light guide of a light guide module, it should be understood that the light guide can include two or more input surfaces, and that structured surface layers having any of the foregoing microstructures or their combinations (e.g., as illustrated in FIG. 8) can be attached to any input surface.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A light guide module, comprising:
a light guide comprising an input surface to receive light; and
a structured surface layer comprising a first surface and a second surface, wherein the first surface is attached to the input surface of the light guide, wherein the second surface comprises microstructures that are operable to spread incident light in the plane of the light guide, and further wherein the second surface is positioned to receive light emitted from an array of light emitting diodes.

2. The light guide module of claim 1 wherein the microstructures comprise symmetrical prism structures.

3. The light guide module of claim 2 wherein an apex angle of at least one prism structure is at least 72 degrees and no greater than 120 degrees.

4. The light guide module of claim 1, wherein a shape of at least one microstructure is selected from the group consisting of intermittent arc, continuous arc, trapezoidal, Fresnel, or sinusoidal shapes.

5. A backlight comprising the light guide module of claim 1, wherein the backlight further comprises an array of light emitting diodes, and further wherein the array of light emitting diodes faces the second surface of the structured surface layer such that at least a portion of light emitted from the array enters the light guide through the second surface of the structured surface layer.

6. A liquid crystal display panel comprising the backlight of claim 5.
